(19) United States
(12) Patent Application Publication
(10) Pub. No.: US 2018/0214784 A1
(43) Pub. Date: Aug. 2, 2018

(54) BEDTIME TOY

(71) Applicant: Peter KLEIN, Brooklyn, NY (US)

(72) Inventor: Peter KLEIN, Brooklyn, NY (US)

(21) Appl. No.: 15/421,823

(22) Filed: Feb. 1, 2017

(51) Int. Cl. A63H 3/00; A63H 3/02; G06F 3/16; H04N 9/31

(52) U.S. Cl. CPC A63H 3/003; A63H 3/02; H04W 84/12; H04N 9/31; A63H 2200/00; G06F 3/16

(57) ABSTRACT

A toy, such as a teddy bear, that communicates with a video playing system to project visual images, including moving images and that outputs an audio signal to lull a child to sleep is provided. The system can project the images and provide the sound or can transmit data to peripheral devices for providing the visual images and the audio signal. A remote control for allowing a parent to monitor the progress of the playback is also provided.

### FIELD OF THE INVENTION

The present invention is generally related to communicating toy animals and, more particularly, to a video/audio system that communicates with toys, for example an interactive bear toy, to play/project videos on room walls, to lull toddlers to sleep.

### BACKGROUND OF THE INVENTION

Bedtime stories have been used for centuries to lull children to sleep. Sometimes children are also shown movies to focus their attention to sooth or calm them and to cause them to get sleepy. For example, Spector, U.S. Pat. No. 5,393,257 discloses a stuffed toy figure which houses a portable audio tape player and includes an earphone headset that can go over the ears of a child. Koenig, U.S. Patent Application Publication No. 2002/0020019 discloses furniture covers, such as blankets or comforters, that also function as sleep enhancing toys. Cooper, U.S. Patent Application Publication No. 2005/0174777 is directed to an interactive lamp that includes speakers and a light source that initiates audible messages. Stone, U.S. Pat. No. 5,059,149 discloses a stuffed animal with compartments for visual or audio materials to be stored inside. Noto, U.S. Pat. No. 4,878,871 discloses a toy that has a cavity that contains a cassette player and can convey personalized messages. Rivera-Weinhold, U.S. Patent Application Publication No. 2005/0066443 is directed to a shaped body pillow and pillowcase that can have the appearance of a character, such as a toy animal as decorations.

DeMars, U.S. Pat. No. 5,713,741, discloses a pillow that includes a radio transmitter activated when pressure is applied to the pillow and the radio receiver located nearby that plays back recorded sound when the radio receiver in the pillow is activated, it also discloses a book with translucent leaves that include writing coordinated with the words of the broadcast from the playback device. In addition, Koenig, U.S. Pat. No. 6,434,769 discloses a dual-purpose plush toys that function both as headrest pillows and as toys containing storybooks or puppets inside.

Audio sounds, text, comforters and toys can be helpful in putting children to sleep. However, a darkened room can be scary for a young child even with the presence of a stuffed animal or toy and even when a story or music is being played. In addition, it is useful to focus the eyes of a child so as to make the eyes sleepy and to lull a child's eyes to close. Also, while light can provide a sense of safety for the child, the continued presence of a bright light can detract from the effort to lull a child to sleep.

The instant inventor previously described a bed time toy, in his U.S. Patent Application Publication No. US 20130280985, the entire contents of which are incorporated by reference herein. In that prior disclosure, the instant inventor describes a plush toy with an incorporated projector. However, implementation practicalities and the necessity to provide the plush toy in many different shapes, appearances and configurations have led to the development of the further improvements described in the present disclosure.

### SUMMARY OF THE INVENTION

Accordingly, it is an object of the present invention to provide toys and related video/audio systems that overcome the drawbacks of the prior art.

It is another object of the present invention to provide interactive, huggable toys that communicate with a video/audio system, the overall functionality of which is to lull children to sleep.

The foregoing and other objects of the invention are realized by a toy based video/audio playing system, for lulling a child to sleep, the toy based video/audio playing system comprising: a toy, the toy having a body with a huggable and soft outer cover and configured to be held by a child while lying in bed and the toy including video/audio playing controls and wireless communication means; a separately provided audio and video playing system configured to enable playing audio and video content, the playing of which is at least partially controlled by the toy via said wireless communication means; a control system in the playing system configured to display video images of said video content unto a wall located above or on a wall opposed to the bed of the child when the toy is actuated to play said video content, and the playing system comprising a storage location for the toy.

Preferably, the toy comprises a mouth with lips and eyes and the lips and eyes are activatable to move and blink when said video content is playing. The system includes a built in light system, which is configured to project a faint light and serves as a night light for a child to allay a fear of darkness, and optionally the toy is configured to emit the audio content of the audio and video content. The toy is battery powered by a rechargeable battery. The playing system comprises a port for loading the audio and video content to said playing system. Further preferably, the system comprises a Wi-Fi facility for enabling loading of the audio and video content. The system comprises a timer for turning off the playing of said audio and video content after a preset time period. Preferably further, the toy comprises an actuating sensor which requires continuous actuation by the grasping of said body of said toy and wherein said playing system is configured to gradually turn off playing of said video content after said activating sensor has been let go by the child. The system comprises a built in alarm clock. The playing system comprises clips by which the playing system can be secured to a wall adjacent the bed. The playing system includes a facility which enables a parent to listen to the sounds from the room where the toy is located. The toy body has a shape of a bear. The toy is provided together with a wardrobe of different clothing. The toy incorporates a built in flashlight configured to enable a child to use the flashlight to guide the child to a bathroom or the like.

Thereby, the toy provides visual images, moving images, including cartoons of the like, together with an audio signal, such as music or a sound to accompany the visual image. The visual image provided by the audio/visual system projects onto a ceiling or wall a visual image while the audio signal is provided to the child to lull the child to sleep. The audio/visual image may also be provided by peripheral devices with which the toy communicates in a wireless fashion.

In general, the toy, which can be a bear or another animal, will have the capabilities to read stories in different languages, as well as to deliver messages, such as “it is time to get up” in the alarm clock mode. It should also be apparent that the bear can be used anytime, not only when going to sleep. It can also be taken on trips. As noted previously, the bear can download various stories and educational games in various languages including via a USB port. In accordance with a further embodiment, the invention includes a house or storage for the bear which can be named the bear cave, for storing therein the toy bear when not in use or, for example, when needed to recharge its batteries.

Other features and advantages of the present invention will become apparent from the following description of the invention, which refers to the accompanying drawings.

### BRIEF DESCRIPTION OF THE DRAWINGS

FIG. 1 illustrates a child holding a toy in bed, the toy interacting with a video/audio system to play video/audio content to the child.

FIGS. 2, 2a, 2b, 2c and 2d illustrate the toy together with the toy housing and various peripheral devices.

FIGS. 3a and 3b are block diagram illustrations of an audio/visual system that interacts with the toy.

FIG. 4 is a block diagram of a typical, prior art home computer set up that provides a Wi-Fi network between various computer, telephone and similar accessories.

FIG. 5 is a block diagram of an alternative implementation of the toy-based video/audio playing system of the present invention, that utilizes features of the Wi-Fi system of FIG. 4.

FIG. 6 is a software block diagram of the master controller of the video/audio playing system of the FIG. 5 embodiment of the present invention.

FIG. 7 is a software block diagram for a phone device to be used by a parent with the systems of the present invention.

### DETAILED DESCRIPTION OF EMBODIMENTS OF THE INVENTION

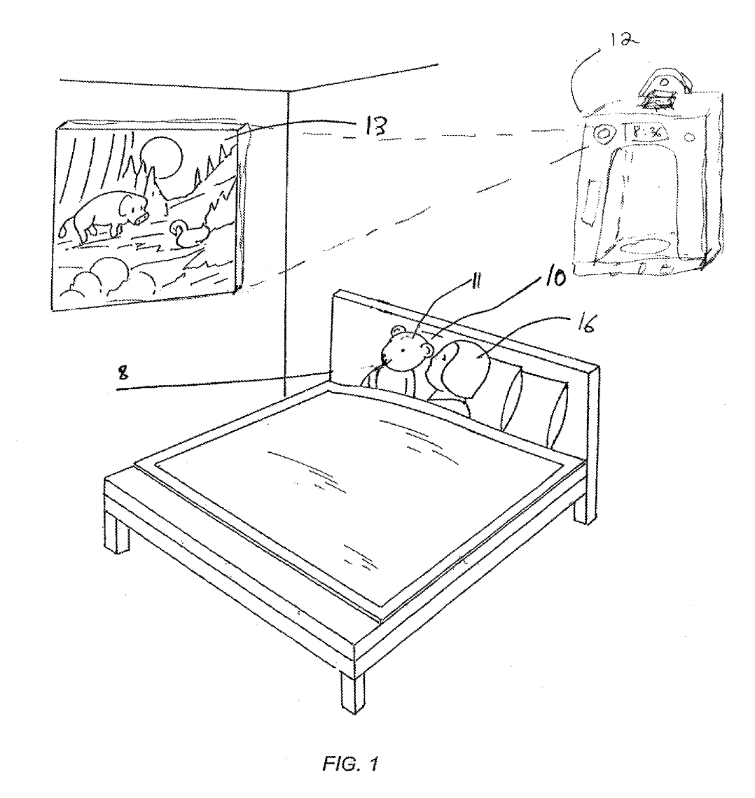

Referring to FIG. 1, a child 16 lies in bed 8 ready to go to sleep while holding a toy 10, and the toy 10 interacts with a projection system 12 to project visual/audio contents, such as a cartoon or a bedtime story or the like on a wall or ceiling in the child's room, in the form of visual images 13 displayed on the wall and accompanied by related audio content.

In this way, the light of the visual images 13 projected on the wall can focus a child's attention and the child's eyes on the images so as to make him or her drowsy and feeling more secure and safe in the darkened bedroom. In addition, by hugging and feeling the familiar and friendly toy 10, which may in the form of a stuffed doll, including a teddy bear or other such dolls, animals, children's characters or the like, or other types of toys, the feeling of security for the child is enhanced in the darkened room and this helps the child to relax, being comforted and going to sleep.

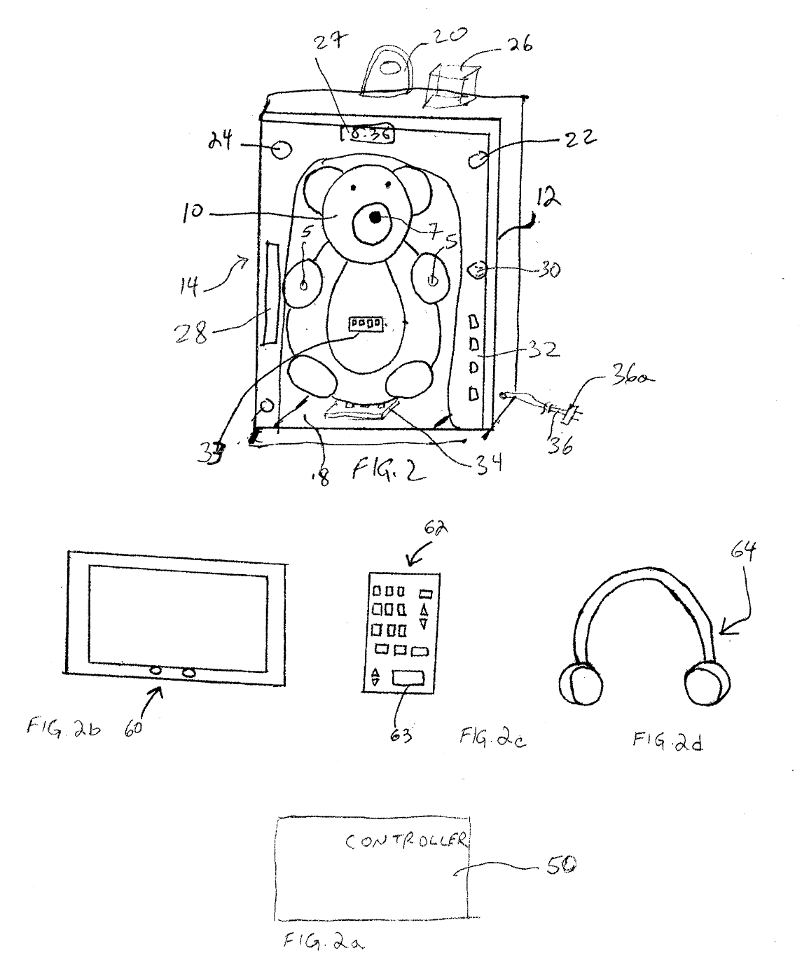

Referring to FIG. 2, the overall projection system 12 has a housing 14 that defines an interior, cave-shaped storage location (a “bear cave”) for the toy 10, with a charging cradle 34 that electrically mates with toy 10 and re-charges its internal batteries when not in use. The overall toy housing and projection system 12 includes a conventional projector inside the housing 14, and a projection lens 22 and related speaker 24 for projecting the images 13 (FIG. 1).

The versatility of the projection system 12 is enhanced by being provided with mounting hardware 20 that enables it to be connected to a wall, with a built-in night light 26, a clock 27, an electronic media receptacle 28 for an SD card or a DVD disc or like media holding video/audio content, and various operator controls 32. The electrical cable 36 with its plug 36a enable power to be delivered to the system 12. The system 12 is further enhanced by also including a child monitor speaker 30 and a camera 31 for monitoring the child, allowing a parent to view and/or hear the child including via a remote control device which can be the mobile telephone 62 with the symbolically indicate screen 63, as shown in FIG. 2c.

Referring further to FIG. 2, the toy 10 may include various controls located for example, on the face 11, arms or stomach of the toy, including Blue Tooth controls for a DVD player, an on/off button, etc., collectively designated as controls 3. The controls 5 on the toy 10 interact with a child monitor and constitute answer and call buttons. An alarm clock off button 7 allows the child to turn off the alarm 27.

The headphone 64 depicted in FIG. 2d enables a child to listen to audio content of a program without disturbing other children that may be sleeping in the room.

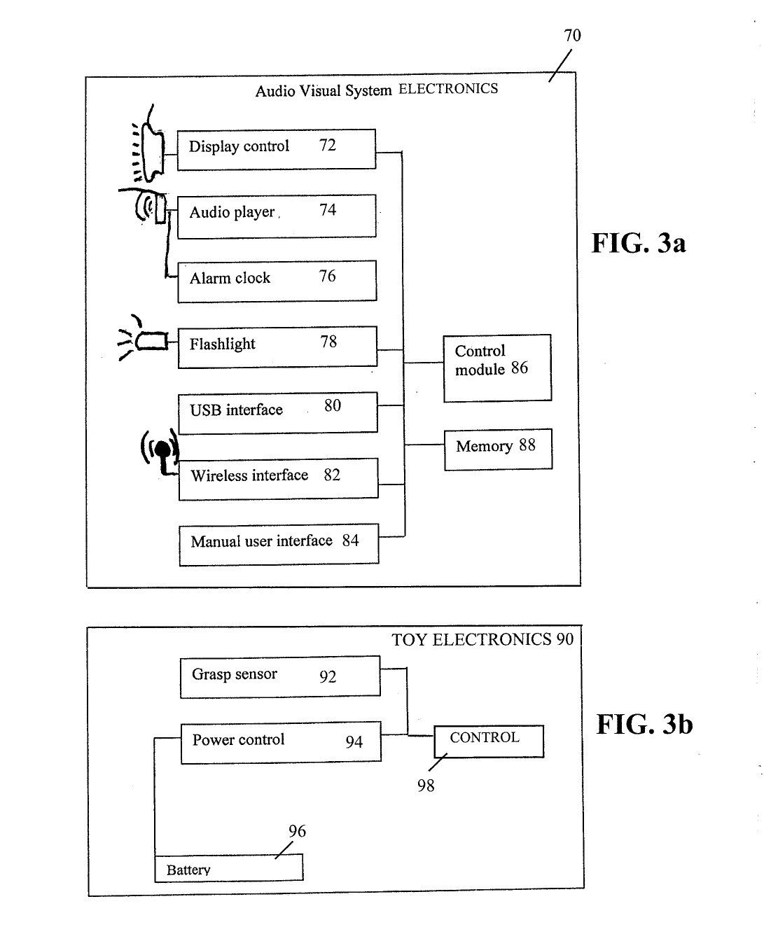

Referring to FIG. 3a, it will be understood that the projection system 12 of FIG. 2 has internal hardware and software that are generally referred to herein as the audio/visual system electronics 70. The system electronics 70 may include display control 72, and audio player controller 74, an alarm clock interface 76, a flashlight 78, a USB interface 80, a wireless interface 82, a manual user interface 84, an overall control module 86 and attendant memory 88.

Referring to FIG. 3b, the toy electronics 90 include a grasp sensor 92, a power control 94, a battery 96, operating under the overall controller 98.

The systems and devices described above relative to FIGS. 2, 2a, 2b, 2c, 2d, 3a and 3b provide the ability to project video/audio content on a wall, for a child to gaze at while being lulled to sleep.

Alternatively, instead of providing the single housing system 12, the invention can be implemented, as shown in FIGS. 2a and 2b, with a video screen 60 that is controlled by an overall controller 50, with other devices such as the alarm clock, child monitor and the headphone 64 being used with the controller 50, to obtain the overall functionality and features described above.

The visual and audio content may be loaded or downloaded to the system 12 via the media interface 28 which can be, as noted above, a hard media or even a USB cable from a computer terminal (not shown), which is connected to the Internet. Alternatively, the data content can be from an entertainment system that includes video discs or hard drive that stores the information.

In the foregoing embodiment, there is always provided a specially built projection system that is uniquely configures to achieve the functionality and features of the present invention. However, in accordance with an alternative embodiment, it is possible to realize the overall functionality and features of the invention using only the stuffed animal 10, as the single, especially constructed hardware, and implementing all the other components and features of the invention with existing hardware utilizing special software application programs written to obtain the invention's functionality, as more specifically described below.

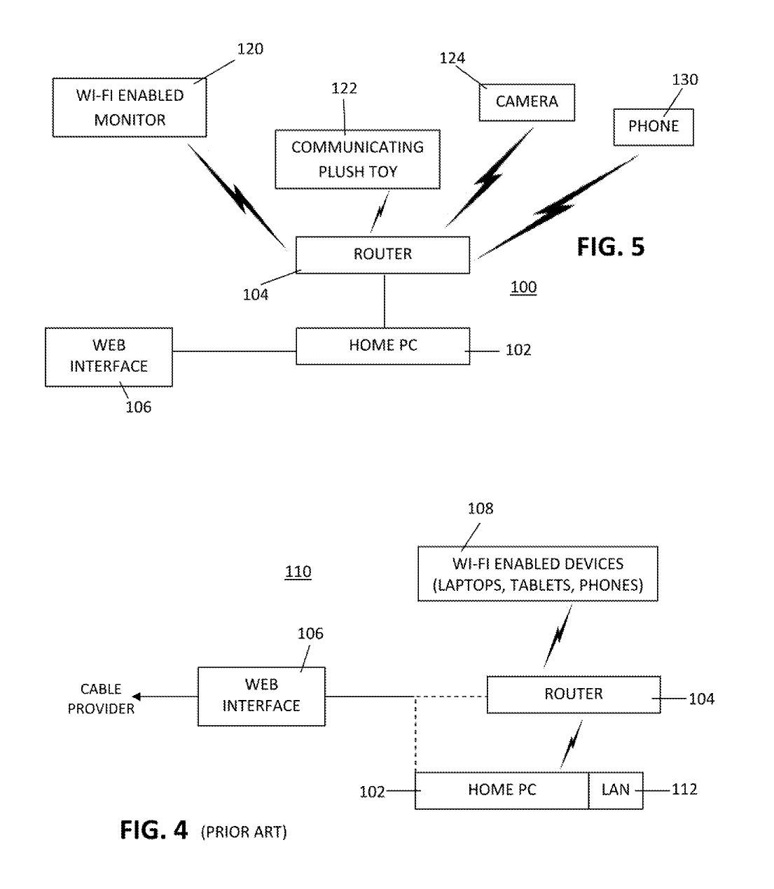

Accordingly, initial reference is made to FIG. 4 that shows a conventional home based computing and communication system. The known system 110 includes a home based PC 102, operating with the router 104 and coupled to worldwide web via interface 106, for example a modem. The router 104 is also connected to Wi-Fi enabled devices such as laptops, tablets, phones and like devices 108. In well-known manner, through the web interface 104, which may be connected to a cable provider, one can download various content/data including software programs for the devices 108, to configure and run a local (Wi-Fi) area network (LAN) 112, the devices including PC 102 and the Wi-Fi enabled devices 108 communicating with each other, exchanging data and operational commands, all in a well-known manner.

Accordingly, in accordance with the present invention and as illustrated in FIG. 5, the home PC 102 is loaded with special software that implements the functionality described above, and is connected to the web interface 106 and via the router 104 to a Wi-Fi enabled monitor 120, to a communicating plush toy 122, to a monitoring camera 124 and to a mobile phone 130.

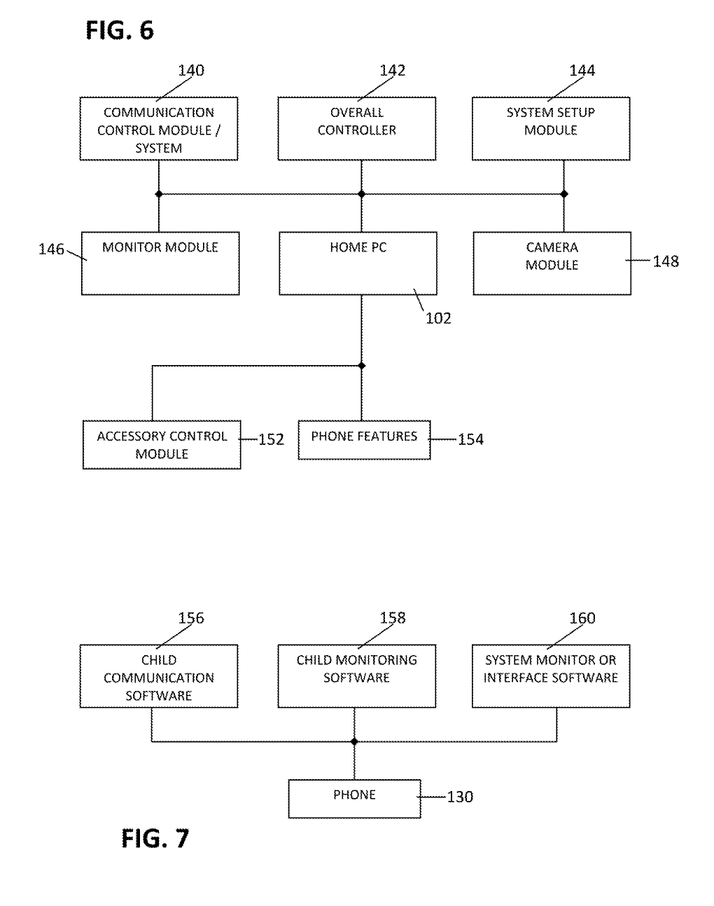

With reference to FIG. 6, the home PC 102 is loaded with software modules or Apps 154, including a communication control module/system 140, an overall controller 142, a system set up module 144, a monitor module 146 to communicate with and provide information to the monitor 120, a camera module 148 for controlling and setting the parameters for communicating with a camera 124, as well as an accessory control module 152.

Thus, the invention can be implemented by the home PC 102 being outfitted with various video/audio content, as described previously and that content can be communicated on the Wi-Fi system 110 to the monitor 120. Application software is also loaded on the phone 130 including a child communication software 156, a child monitoring software 158 and a system monitor or interface software 160.

With the above described, software-based implementation, the applications (Apps) running on the phone 130 can be used to initiate playing of specific content on the monitor 120, or enabling the mobile device 130 to obtain visual images through the Wi-Fi system from the camera 124 showing the child, including whether the child is still awake or already asleep, receiving instructions from the toy 12, for example, when the child presses one of the arms or the nose of the toy or another toy button control signifying that the child is seeking the parent's attention, and so on. At the same time the software allows the parent to override the video playing on the monitor and instead play a pre-stored video/audio piece on the monitor, which shows, for example, the mother speaking to the child, while simultaneously allowing the mother to speak to and hear the child through the audio communication channels, for example, via the child monitor (creating the appearance of the mother speaking to the child directly from the monitor), all of which will serve to calm the child and discourage the child from getting out of bed and running to the mother in another room.

The visual content 13 being played may be a bedside story, a cartoon or other type of animation, or a more traditional motion picture content or may be still cartoons or photos either purchased off the shelf or provided by the user. The photos may be photos of the child's family, the child's toys or recent family vacation or the like.

The alarm clock 27 included in the audio/visual system 12 may serve both to wake up the child at a certain time by providing an alarm, an audio signal, such as music or a story or the visual images 13, such as a photograph, or story, or a combination of visual image or audio. In addition, alarm clock 27 can also be set to sleep mode to gradually decrease volume and to decrease brightness level of visual image 13, so as to lull the child 16 to sleep after a set period of time. This gradual dimming of the visual image 13 and reducing a volume of audio 14 may be over a period of time set by the user or set in a default mode, such as over a 5 minute or a 2 minute interval.

A dimming mode can also be entered automatically when the end of the story is near, such as five minutes or two minutes before the end of the story, or can be entered via parent via a remote control unit 62 which can communicate with audio/visual system 12 or 50. Thus, parents or other caretakers can monitor the child and can shut off playback directly or can cause audio/visual system 12 to enter a dimming mode in which visual images 13 are gradually dimmed and the volume of the audio is gradually diminished over a set period such as over three minute or five minute or two minute periods.

Audio messages can be selected from a range of preset messages in a variety of languages or may be recorded by the parent via USB port controlled by the interface 28. For example, whether the alarm clock 27 plays “good morning” or “good morning it's time to get up” or a random or pseudo random combination of such sayings can be set in advance by the parents or the alarm clock 27. In addition, a range of stories, music, and educational content can be uploaded to a memory of the audio/visual system 12 via a USB port or other type of data interface, such as HDMI cable (connected to the monitor 60), disc, firmware or card via the interface 28, or such content can be uploaded to a toy via wireless interface, which may be a Bluetooth interface or may communicate with wireless router or other type of wireless device providing content.

In addition, various clothing or apparel may also be provided for the toy 10, so that the child can dress the toy according to the style of toy provided. For example, if the toy is provided as a teddy bear, then the attire provided may vary from a country bear style clothing to a sleepy time bear costume with a tasseled sleeping cap.

In general, the toy, which can be a bear or another animal, will have the capabilities to read stories in different languages, as well as to deliver messages, such as “it is time to get up” in the alarm clock mode. It should also be apparent that the bear can be used anytime, not only when going to sleep. It can also be taken on trips. As noted previously, the bear can download various stories and educational games in various languages including via a USB port. In accordance with a further embodiment, the invention includes a house or storage for the bear which can be named the bear cave, for storing therein the toy bear when not in use or, for example, when needed to recharge its batteries.

Although the present invention has been described in relation to particular embodiments thereof, many other variations, combinations of features and modifications and other uses will become apparent to those skilled in the art. It is preferred, therefore, that the present invention be limited not by the specific disclosure herein, but only by the appended claims.

1. A toy based video/audio playing system, for lulling a child to sleep, the toy based video/audio playing system comprising:
a toy, the toy having a body with a huggable and soft outer cover and configured to be held by a child while lying in bed and the toy including video/audio playing controls and wireless communication means;
a separately provided video playing system configured to enable playing audio and video content, the playing of which is at least partially controlled by the toy via said wireless communication means; and
a control system in the playing system configured to display video images of said video content on said separately provided video playing system, said separately provided video playing system being located above or on a wall opposed to the bed of the child when the toy is actuated to play said video content,
said playing system comprising a storage house for the toy; and the storage house comprises:
a) a night light
b) an alarm clock;
c) a media slot for receiving video content that is playable on said separately provided video playing system;
d) a child monitor comprising a microphone that enables a parent to listen to sounds made by the child; and
e) a charging plug that enables charging of an internal battery of the toy.

2. The toy based video/audio playing system of claim 1, wherein the toy comprises a mouth with lips and eyes and said lips and eyes are activatable to move and blink when said video content is playing.

3. The toy based video/audio playing system of claim 1, including a built in light system, which is configured to project a faint light and serves as said night light for the child to allay a fear of darkness.

4. The toy based video/audio playing system of claim 1, wherein the toy is configured to emit the audio content of said audio and video content.

5. (canceled)

6. (canceled)

7. The toy based video/audio playing system of claim 1, wherein said toy house comprises a Wi-Fi facility for enabling loading of said audio and video content.

8. The toy based video/audio playing system of claim 1, wherein said toy house comprises a timer for turning off the playing of said audio and video content after a preset time period.

9. The toy based video/audio playing system of claim 1, wherein said toy comprises an actuating sensor which requires continuous actuation by the grasping of said body of said toy and wherein said playing system is configured to gradually turn off playing of said video content after said activating sensor has been let go by the child.

10. (canceled)

11. The toy based video/audio playing system of claim 1, wherein said playing system comprises clips by which the toy house can be secured to a wall adjacent the bed.

12. (canceled)

13. The toy based video/audio playing system of claim 1, wherein the toy body has a shape of a bear.

14. The toy based video/audio playing system of claim 1, wherein the toy is provided together with a wardrobe of different clothing.

15. The toy based video/audio playing system of claim 1, wherein the toy incorporates a built in flashlight configured to enable a child to use the flashlight to guide the child to a bathroom.
